(19) United States
(12) Patent Application Publication
(10) Pub. No.: US 2010/0188520 A1
(43) Pub. Date: Jul. 29, 2010

(54) IMAGING DEVICE AND STORAGE MEDIUM STORING PROGRAM

(75) Inventors: Tetsuo IN, Yokohama-shi (JP); Shoei NAKAMURA, Yokohama-shi (JP)

Correspondence Address: OLIFF & BERRIDGE, PLC, P.O. BOX 320850, ALEXANDRIA, VA, 22320-4850, US

(73) Assignee: NIKON CORPORATION, TOKYO (JP)

(21) Appl. No.: 12/689,510

(22) Filed: Jan. 19, 2010

(30) Foreign Application Priority Data
Jan. 23, 2009 (JP) 2009-013135

(51) Int. Cl. G06K 9/46; H04N 5/228

(52) U.S. Cl. 348/222.1; 382/195; 348/E05.031

(57) ABSTRACT

An imaging device includes an imaging section imaging a subject by either of all-pixel readout of an imaging sensor and thinning-out readout and generating an image, a face detection section detecting a face of the subject by using the image imaged by the thinning-out readout, a facial recognition section recognizing respective forms of a corner of mouth, teeth, and a tail of eyes along with the face of the subject being detected, an expression determination section determining that the subject is smiling when the respective forms of the corner of mouth, the teeth, and the tail of eyes being recognized match at least one of smile conditions, and a control section giving an imaging instruction of the subject by the all-pixel readout to the imaging section when the subject is determined to be smiling by the expression determination section.

### CROSS REFERENCE TO THE RELATED APPLICATIONS

This application is based upon and claims the benefit of priority from Japanese Patent Application No. 2009-013135, filed on Jan. 23, 2009, the entire contents of which are incorporated herein by reference.

### BACKGROUND

1. Field

The present application relates to an imaging device and a storage medium storing a program capable of capturing an image based on a smile detection of a person being a subject.

2. Description of the Related Art

In recent years, technical development of image processing such as face detection has been extensively done to capture an image of a person by automatically activating a release of a digital camera when the person being a subject is in a desired facial expression or a pose.

For example, Japanese Unexamined Patent Application Publication No. 2004-294498 discloses a technique of storing a form data of predetermined desired facial expressions and poses in advance, extracting forms of the facial expression and the pose of a subject being a user from a captured image, comparing the forms with the stored form data of the facial expressions and poses, calculating coincidence between them, and thereby, determining that they are the facial expression and the pose desired by the user when the coincidence becomes a predetermined value or more, and capturing the image.

However, in general, an expression determination of smile and on the like are performed based on plural conditions such as forms of a tail of eyes, a corner of mouth of a face, and it is necessary that all of the conditions satisfy certain conditions in a conventional art. If the predetermined value of the coincidence is decreased little by little such as Japanese Unexamined Patent Application Publication No. 2004-294498, there is a case when it is not determined as the smile as for a person who is not good at putting on a smile.

### SUMMARY

A proposition of the present application is to provide a technique capable of performing a determination of smile of a person with high accuracy in a photographing of the person being a subject with considering the problems held by the conventional art.

To solve the above-stated problems, an imaging device according to the present embodiments includes an imaging section imaging a subject by either of all-pixel readout and thinning-out readout of an imaging sensor and generating an image, a face detection section detecting a face of the subject by using the image imaged by the thinning-out readout, a facial recognition section recognizing respective forms of a corner of mouth, teeth, and a tail of eyes along with the face of the subject being detected, an expression determination section determining that the subject is smiling when the respective forms of the corner of mouth, the teeth, and the tail of eyes being recognized match at least one of smile conditions made up of three conditions determined based on respective forms of a corner of mouth, teeth, and a tail of eyes, and a control section giving an imaging instruction of the subject by the all-pixel readout to the imaging section when the subject is determined to be smiling by the expression determination section.

Moreover, the imaging device may further include an operation member capable of arbitrarily setting and selecting the smile conditions.

The control section may stop giving the imaging instruction to the imaging section when the expression determination section determines that none of the smile conditions is satisfied.

The imaging device may further include a storage section storing images of faces of a plurality of subjects and each of the smile conditions of the plurality of subjects, wherein the control section may set the smile conditions of the subject facial recognized by the facial recognition section to the expression determination section when the face of the subject recognized by the facial recognition section is determined to be matching one of the faces of the plurality of subjects stored in the storage section.

The control section may further include a condition updating section updating the smile conditions of the subject stored in the storage section based on a determination result of the expression determination section to the subject in a newly imaged image, and the control section may set the smile conditions being updated to the expression determination section.

Further, the control section may decrease number of the smile conditions and set the smile conditions whose number being decreased to the expression determination section by each predetermined time interval when the facial recognition section determines that a subject is a new subject which does not exist in the storage section, or when number of update times of the smile conditions of the subject updated by the condition updating section is less than predetermined number of times.

The control section may change the smile conditions of the subject to approximate initial settings and set the smile conditions of the subject being changed to the expression determination section when determining that number of update times of the smile conditions of the subject updated by the condition updating section is more than predetermined number of times.

The imaging device may further include a display section displaying a determination result of the smile conditions determined by the expression determination section when the subject is imaged by the imaging section.

The control section may add a determination result of the smile conditions of the subject at a time of imaging determined by the expression determination section to the image in which the imaging section images the subject.

A computer-readable storage medium according to the present embodiments stores a program causing a computer to execute an input operation reading an image in which a subject is imaged by an imaging sensor, a face detection operation detecting a face of the subject by using the image, a facial recognition operation recognizing respective forms of a corner of mouth, teeth, and a tail of eyes along with the face of the subject being detected, an expression determination operation determining that the subject is smiling when the respective forms of the corner of mouth, the teeth, and the tail of eyes being recognized match at least one of smile conditions made up of three conditions determined based on respective forms of a corner of mouth, teeth, and a tail of eyes, and a storage operation storing the smile conditions at a time the subject is determined to be smiling by each of the subjects when the expression determining operation determines that the subject is smiling.

According to the present application, it is possible to perform a determination of smile of a subject with high accuracy in photographing of a person being the subject.

### BRIEF DESCRIPTION OF THE DRAWINGS

FIG. 1 is a schematic diagram illustrating a configuration example of a digital camera 100 according to one embodiment of the present invention.

FIG. 2 is a view illustrating an example of a person data table 15 stored in a storage section 10 of the digital camera 100 according to the one embodiment of the present invention.

FIG. 3 is a flowchart illustrating a photographing procedure in a smile photographing mode of the digital camera 100 according to the one embodiment of the present invention.

FIG. 4 is a view illustrating an example of a screen 20 for a condition setting required in the smile photographing in the one embodiment of the present invention.

FIG. 5 is a view illustrating an example of a subject in the one embodiment of the present invention.

FIG. 6 is views illustrating a display example of a still image 50 actually image-captured by the digital camera 100 according to the one embodiment of the present invention.

### DESCRIPTION OF THE PREFERRED EMBODIMENTS

### One Embodiment

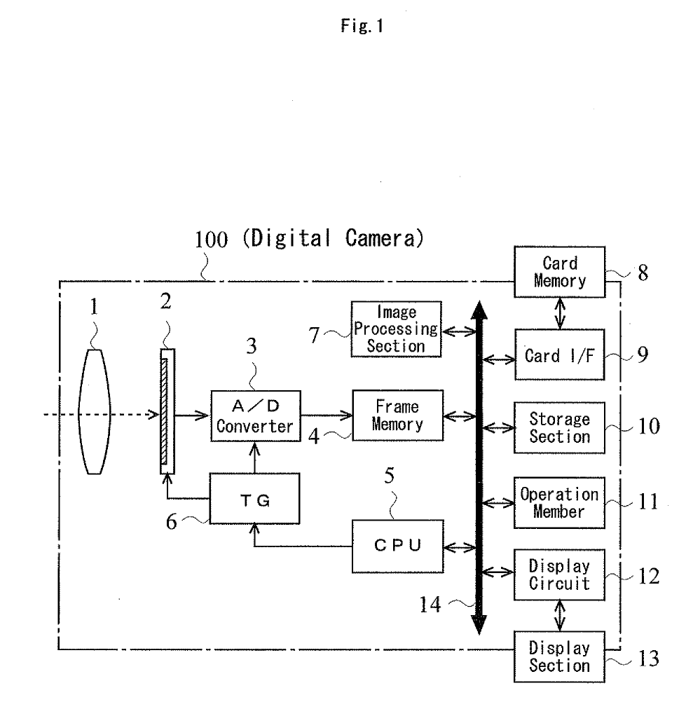

FIG. 1 is a configuration diagram of a digital camera 100 according to one embodiment of the present invention.

The digital camera 100 includes an imaging lens group 1, an imaging sensor 2, an A/D converter 3, a frame memory 4, a CPU 5, a timing generator (TG) 6, an image processing section 7, a card memory 8, a card interface (card I/F) 9, a storage section 10, an operation member 11, a display circuit 12 and a display section 13. The frame memory 4, the CPU 5, the image processing section 7, the card I/F 9, the storage section 10, the operation member 11 and the display circuit 12 are coupled so that information transmission is possible by a bus 14. Besides, the imaging sensor 2 and the A/D converter 3 are respectively coupled to the CPU 5 via the TG 6 to be controlled.

The imaging lens group 1 includes plural optical lenses, and forms a subject image at a light-receiving surface of the imaging sensor 3.

The imaging sensor 2 operates based on a timing pulse generated by the TG 6 receiving an instruction of the CPU 5, obtains the subject image formed by the imaging lens group 1 provided at a front side thereof, and converts it into an image signal to output. Incidentally, the imaging sensor 2 of the present embodiment is able to perform an image-capturing of the subject image in a through image for live viewing and in a moving image by capturing the subject image with all pixels or by reading a pixel value by thinning out in a horizontal scanning direction or in a vertical scanning direction based on the instruction of the CPU 5. A semiconductor image sensor and so on such as a CCD and a CMOS can be appropriately selected to be used as the imaging sensor 2.

The image signal output from the imaging sensor 2 is converted into a digital signal at the A/D converter 3. The converted digital image signal is temporary stored at the frame memory 4, and thereafter, transferred to the storage section 10 or the image processing section 7. Incidentally, it is preferable that the A/D converter 3 includes an analog front-end having an amplifying section amplifying the analog signal from the imaging sensor 2 in accordance with ISO sensitivity. Further, an arbitrary nonvolatile semiconductor can be appropriately selected to be used as the frame memory 4 among semiconductor memories.

The CPU 5 reads a control program stored in the storage section 10 to initialize the digital camera 100 when a power of the digital camera 100 is turned on by a power button operation of the operation member 11 by a user. The CPU 5 receives an instruction from the user via the operation member 11, then gives an image-capturing instruction of a still image-capturing by all pixels of the subject image or the image-capturing of the through image and the moving image by thinning-out readout to the TG 6 based on the control program. Further, in the present embodiment, the CPU 5 performs a face detection, a facial recognition and an expression determination based on smile conditions of a subject inside the through image by using the through image from the imaging sensor 2 when a smile photographing mode is selected by a mode setting button of the operation member 11 and a release button is pressed as it is described later. When it is determined that the subject is smiling, the CPU 5 forcibly gives the image-capturing instruction of the still image of the subject image by all pixels of the imaging sensor 2. Besides, the CPU 5 performs controlling of an image processing of the captured still image, the moving image, and so on at the image processing section 7, storing of the image to the card memory 8 or the storage section 10, or a display on the display section 13 and so on. A CPU of a general computer can be used as the CPU 5.

The image processing section 7 is a digital front-end circuit, and performs image processing such as a pixel interpolation processing, a color transformation processing, a white-balance correction for the image data such as the still image from the frame memory 4 and the storage section 10.

The card memory 8 is coupled detachably to the card I/F 9. The image processing is performed for the image stored at the frame memory 4 and the storage section 10 at the image processing section 7 based on the instruction of the CPU 5, and thereafter, the image is stored at the card memory 8 as a file in Exif format, YUV format, and so on.

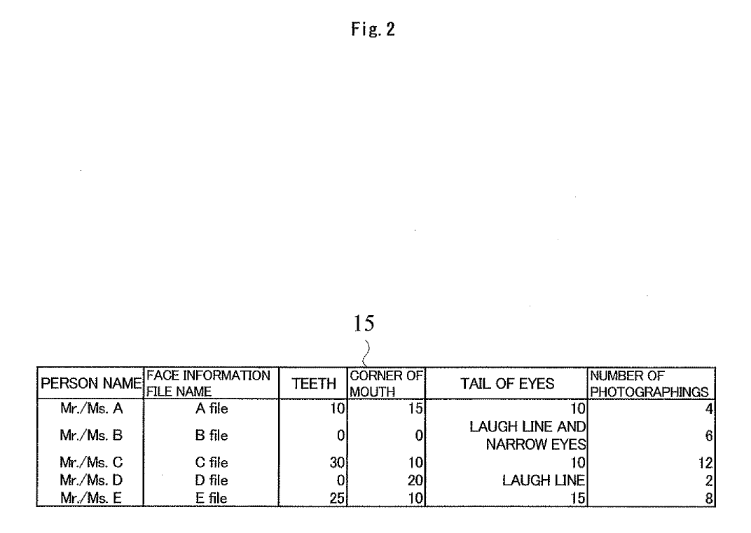

The storage section 10 stores the still image, the moving image, and so on captured by the digital camera 100, and the control program to control the digital camera 100 by the CPU 5. Further, in the present embodiment, the storage section 10 stores a person data table 15 including a file name storing an image and face parts information such as teeth, a corner of mouth, a tail of eyes of each person to be the subject, later-described smile conditions and the number of photographing times of each person as illustrated in FIG. 2. These program and data stored in the storage section 10 can be appropriately referred to from the CPU 5 via the bus 14. A general hard disk device, a magnetic optical disk device, an arbitrary nonvolatile memory being a semiconductor memory, or the like can be appropriately selected to be used as the storage section 10.

The operation member 11 outputs an operation signal in accordance with contents of member operations by the user to the CPU 5. The operation member 11 has, for example, the power button, the mode setting button of a photographing mode and so on, a release button and so on. Incidentally, the operation member 11 may be a button in touch panel type displayed on a screen of the display section 13.

The display section 13 displays the moving image and the image of the through image and so on captured by the imaging sensor 2, a mode setting screen and so on via the display circuit 12. A liquid crystal display and so on can be appropriately selected to be used as the display section 13.

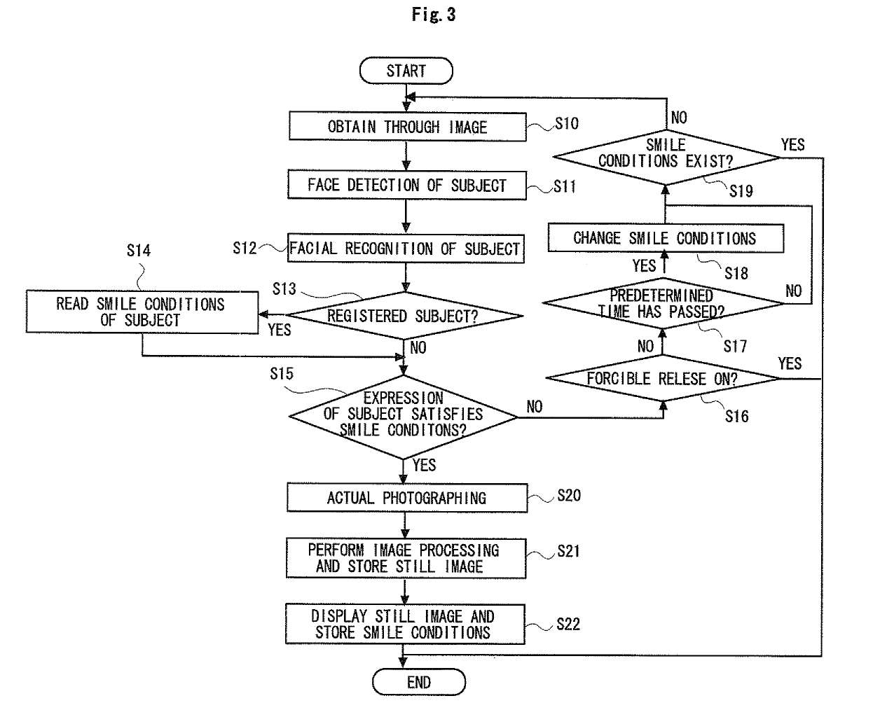

Next, processes in the smile photographing mode by the digital camera 100 according to the present embodiment are described with reference to a flowchart in FIG. 3. Incidentally, in the present embodiment, it is described as for a case when a person who is not registered to the person data table 15 of the storage section 10 is image-captured.

At first, when the power button of the operation member 11 is pressed by the user, then the CPU 5 reads the control program stored in the storage section 10 of the digital camera 100 and initializes the digital camera 100. At the same time, the CPU 5 reads the person data table 15 stored at the storage section 10, and stores in an internal memory (not illustrated) of the CPU 5.

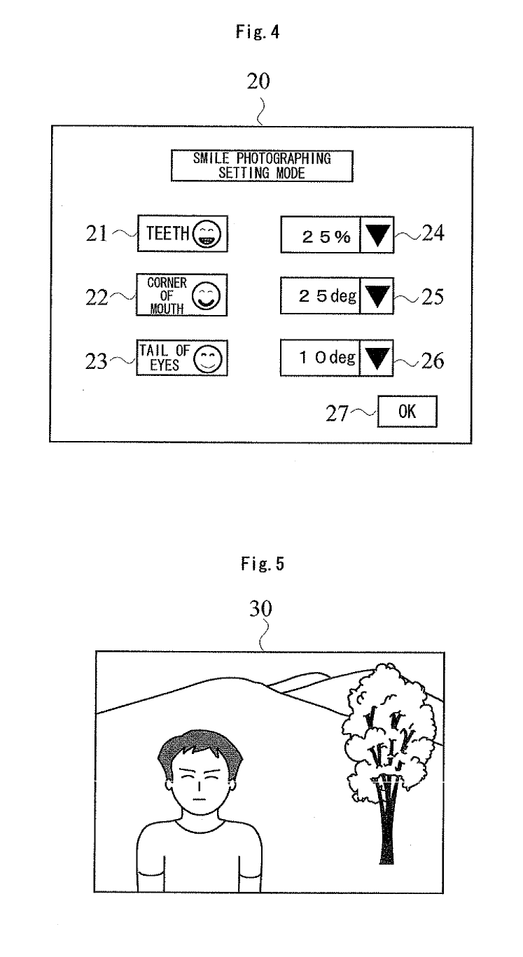

Next, the user performs settings of the photographing mode setting and so on by using the mode setting button of the operation member 11. In this embodiment, the user selects the smile photographing mode by using the mode setting button. A screen 20 for a condition setting required in the smile photographing as illustrated in FIG. 4 is then displayed on the display section 13. As illustrated in FIG. 4, in this embodiment, three conditions of the teeth, the corner of mouth, the tail of eyes of the person being the subject are set as the simile conditions, and the settings of respective conditions are performed by using setting sections 24 to 26. FIG. 4 illustrates initial setting values of the respective conditions set by the user (or a default) in this embodiment.

Here, in an item 21 of the teeth, a ratio occupied by a white portion of the teeth relative to an area of the mouth is set in the later-described facial recognition by the CPU 5. The user is able to set an arbitrary value via the setting section 24. In an item 22 of the corner of mouth, an angle made by a line coupling between a position of the corner of mouth and a center position of the mouth when the mouth is closed in a straight line with a horizontal direction relative to a gravity direction is set. The user is able to set an arbitrary value at the setting section 25. Finally, in an item 23 of the tail of eyes, an angle of the tail of eyes lowered for how many degrees relative to an initial position is set. The user is able to set an arbitrary value at the setting section 26. Incidentally, as for the item 23 of the tail of eyes, it is preferable that items of conditions such as a laugh line, narrow eyes in addition to the setting of the angle of the tail of eyes are provided for a person who is not good at putting on a smile. Incidentally, when it is already in the smile mode when the power is turned ON, the smile conditions are succeeded from the previous conditions (at a power off time). When the smile conditions are changed, for example, the values of the smile conditions are reset by once setting the mode into another mode, and setting into the smile mode again to set the smile conditions.

After all of the settings of the smile photographing mode as stated above are performed, the user presses an OK button 27 to finish the settings. The user then presses the release button of the operation member 11 to capture the image according to the smile photographing mode. Processes from a step S10 to a step S22 in FIG. 3 are then performed. Incidentally, in the following description, it is described as for a case when an image in which there is one person as illustrated in FIG. 5 is captured.

Step S10: The CPU 5 makes the imaging sensor 2 capture a subject image by the thinning-out readout at a predetermined frame rate (for example, 30 fps) for the TG 6, obtains a generated through image 30 for a live view display, and displays on the display section 13.

Step S11: The CPU 5 determines whether or not a person is photographed in the obtained through image 30, and when the person is photographed, a face of the person is detected. Here, a method of the face detection performed by the CPU 5 can be performed by using an appropriately publicly known method. Specifically, the CPU 5 extracts feature points of an amount of image characteristics such as an edge amount from the obtained through image 30 to detect a region, size, and so on of the face of each person.

Step S12: The CPU 5 performs the facial recognition as for who is the person detected at the step S11. A publicly known method can be appropriately used as for the method of the facial recognition performed by the CPU 5. Specifically, the CPU 5 asks positions of the feature points of the face, sizes of the face parts such as the teeth, the corner of mouth, the tail of eyes of the face, and so on based on the feature points of the face of the detected person.

Step S13: The CPU 5 compares the image of the person detected at the step S11 and the face parts recognized at the step S12 with the images and the face parts information of the respective persons registered to the person data table 15, and determines whether or not the person being the subject is the person registered to the storage section 10. Specifically, the CPU 5 compares the image of the person detected at the step S11 and the face parts recognized at the step S12 with the images and the face parts in the person data table 15, and asks a degree of similarity while adjusting a relative position, a size and so on of the feature points. The CPU 5 determines that the person of the through image 30 is any of the registered persons when the degree of similarity is a predetermined value (for example, 80%) or more, and goes to step S14 (YES side). On the other hand, when the degree of similarity is less than the predetermined value, the CPU 5 determines that the person of the through image 30 is not any of the registered persons, and goes to step S15 (NO side).

Step S14: The CPU 5 reads the smile conditions made up of the teeth, the corner of mouth, and the tail of eyes stored in the person data table 15 corresponding to the person of the through image 30, and sets the smile conditions by replacing the setting values of the smile conditions initially set by the user. The CPU 5 goes to the step S15.

Step S15: The CPU 5 determines whether or not the forms of the teeth, the corner of mouth, and the tail of eyes being the face parts of the person asked at the step S12 satisfy the respective conditions of the smile conditions initially set by the user when the person is not registered to the storage section 10. When the person is registered to the storage section 10, the CPU 5 determines whether or not the respective conditions of the smile conditions set at the step S14 are satisfied. When the CPU 5 determines that all of the smile conditions are satisfied, the CPU 5 goes to step S20 (YES side). On the other hand, when it is determined that not all of the smile conditions are satisfied, the CPU 5 goes to step S16 (NO side).

Step S16: The CPU 5 determines whether or not the subject image is captured by the forcible full-pressing of the release button by the user without waiting until the smile conditions are satisfied. When it is determined to be forcibly released (YES side), the CPU 5 transfers the captured still image to the image processing section 7 to perform the image processing such as the pixel interpolation processing, the color transformation processing, and the white-balance correction, and thereafter, stores the image to the card memory 8 or the storage section 10, and finishes the processes in the smile photographing mode. On the other hand, the CPU 5 goes to step S17 (NO side) when it determines that it is not forcibly released.

Step S17: The CPU 5 determines whether or not a predetermined time has passed to change the smile conditions at subsequent step S18 by every predetermined time (for example, 30 seconds in this embodiment) from the time when the image-capturing in the smile photographing mode is started. When the CPU 5 determines that the predetermined time has passed, the CPU 5 goes to the step S18 (YES side). On the other hand, the CPU 5 goes to step S19 when it determines that the predetermined time has not passed.

Step S18: The CPU 5 changes the smile conditions. Specifically, for example, the CPU 5 resets a value of a condition which is the worst satisfied into “0” (zero) (namely, removes the condition) among the conditions such that the teeth is 25%, the corner of mouth is 25 degree, and the tail of eyes is 10 degree which are the smile conditions initially set by the user, because the CPU 5 determines that the person of the through image 30 is not good at putting on a smile, the set values of the respective conditions of the smile conditions are inadequate, or the like when it is the first time for the digital camera 100 to capture the image of the person of the through image 30, to set the above-stated smile conditions as new smile conditions. Otherwise, the CPU 5 may change the value of the worst satisfied condition into a small value, and set as the new smile conditions. The CPU 5 may remove the laugh line, the narrow eyes, and so on from the smile conditions or may change the setting of numerical values when the condition setting of the laugh line, the narrow eyes, and so on are made as the condition of the tail of eyes, but such form is not recognized in the face parts of the person asked at the step S12. The CPU 5 then goes to the step S19.

Step S19: The CPU 5 determines whether or not there is at least one or more conditions in the changed new smile conditions because it is necessary that at least one condition exists after the change of the smile conditions performed at the step S18. When the CPU 5 determines that there is one or more smile conditions, the CPU 5 goes to the step S10 (YES side), a next new through image 30 is obtained, and the processes from the step S10 to the step S19 are performed. On the other hand, when the CPU 5 determines that there is not even one smile condition, (all of the respective conditions have the values “0” (zero) and so on), the photographing in the smile photographing mode is stopped and the processes are finished.

Step S20: The CPU 5 gives an instruction of an actual capturing of the subject image by all pixels to the imaging sensor 2 via the TG 6 because it is determined that the person being the subject is smiling at the step S15, and a still image is temporary stored at the frame memory 4.

Step S21: The CPU 5 transfers the still image captured at the step S20 to the image processing section 7 via the bus 14. The image processing section 7 performs the image processing such as the pixel interpolation processing, the color transformation processing, and the white-balance correction for the still image, and changes the still image into an image file in the Exif format and so on in which a determination result of the smile conditions being an occasion of capturing of the still image is added to the processed still image. The image processing section 7 stores the image file to the memory card 8 or the storage section 10 via the bus 14. At the same time, the CPU 5 newly registers the file name in which a name of the image-captured person, the image of the face, and the face parts information are stored, the smile conditions made up of the three conditions, and the number of image-capturing times (a value “1” for this time) to the person data table 15 in FIG. 2.

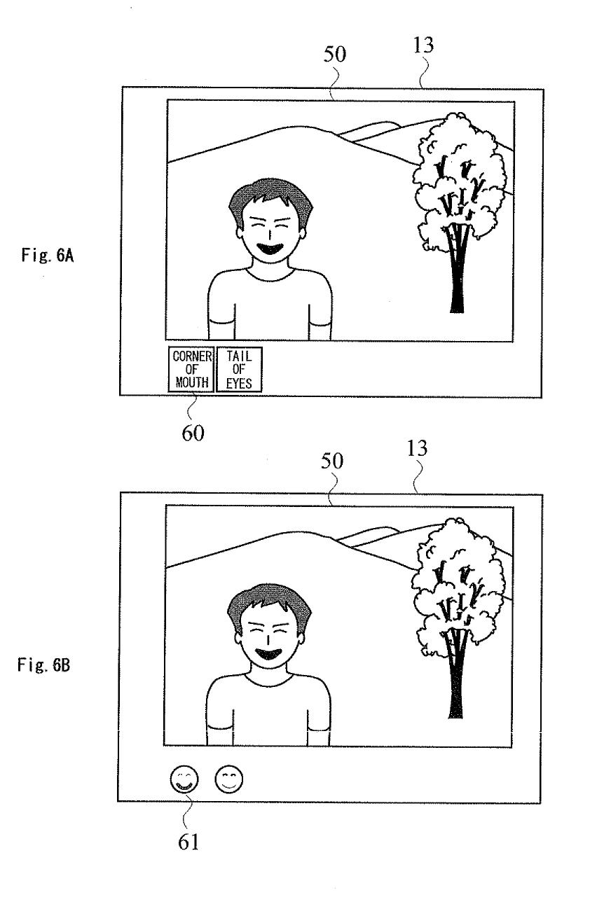

Step S22: The CPU 5 displays a still image 50 which is processed by the image processing section 7 at the step S21 on the display section 13 as illustrated in FIG. 6. At the same time, the CPU 5 displays a description about when the person image-captured in the still image 50 is captured by satisfying which smile conditions as characters 60 in FIG. 6 (a) and an icon 61 of an illustration in FIG. 6 (b). Accordingly, it is possible for the person being the subject to objectively know that the features of his/her smile exists in the corner of mouth or the tail of the eyes.

As stated above, in the present embodiment, it is possible to perform the determination of the smile of the person being the subject with high accuracy by appropriately changing the smile conditions made up of the three conditions of the teeth, the corner of mouth, and the tail of eyes even for the person who is not good at putting on a smile when the person who is not registered to the person data table 15 is image-captured. Accordingly, it is possible to obtain the image of the best smile for the person.

Besides, the values of the smile conditions determined to be the smile of the newly image-captured person are newly registered to the person data table 15, and therefore, it is possible to surely determine the smile of the person when the person is image-captured next time.

### Other Embodiments

A digital camera according to another embodiment of the present invention is the same as the digital camera 100 according to the one embodiment in FIG. 1, and therefore, descriptions relating to each component and operations thereof are not given. A different point of the present embodiment from the one embodiment is that a subject person to be image-captured is the person registered to the person data table 15 stored in the storage section 10.

Accordingly, in image-capturing processes in the smile photographing mode of the digital camera 100 according to the present embodiment, the processes from the step S10 to the step S22 which are the same as the flowchart in FIG. 3 are basically performed. However, a different point of the processes according to the present embodiment from the processes in the one embodiment is that the registered person is updated based on the conditions of the teeth, the corner of mouth, and the tail of eyes to be the smile conditions when the person is newly image-captured, and the conditions of the teeth, the corner of mouth, and the tail of eyes of the smile conditions of the person stored in the person data table 15 in the process at the step S21. Specifically, when, for example, the image-captured person is a person A, the CPU 5 calculates, for example, average values and so on as for the respective conditions when the conditions of the teeth, the corner of mouth, and the tail of eyes of the smile conditions in the person data table 15 are 10%, 15 degree, and 10 degree, and values of the teeth, the corner of mouth, the tail of eyes of the smile conditions when the person is newly image-captured this time are 15%, 12 degree, and 15 degree, while considering the number of image-capturing times up to that time, and updates a column of the person A in the person data table 15 with the calculated new values as new smile conditions of the person A.

As stated above, in the present embodiment, it is possible to perform the determination of the smile of the person being the subject with high accuracy and to obtain the image of the best smile for the person by appropriately updating the smile conditions made up of the three conditions of the teeth, the corner of mouth, and the tail of eyes even when the person already registered to the person data table 15 is image-captured.

### <<Supplementary Items of Embodiment>>

In the one and the other embodiments, the person being the subject to be image-captured to the through image 30 is one person, but the present invention is not limited to the above, and it is possible to apply a case when plural persons are image-captured. In this case, for example, the image-capturing may be performed by performing the face detections by each of the persons at the step S11, by obtaining the images and the face parts information of the faces by each of the persons at the step S12, by performing the determinations whether or not the persons are registered to the person data table 15 by each of the persons at the step S13, and by performing the determination whether or not bring the smile conditions by each of the persons at the step S15. Otherwise, the face detections are performed by each of the persons at the step S11, and thereafter, the image-capturing may be performed based on the determination by only the smile conditions of the person registered to the person data table 15, the person who is not registered to the person data table 15, or an arbitrary selected person among the detected persons.

Incidentally, in the one and the other embodiments, the user sets the conditions of the teeth, the corner of mouth, the tail of eyes of the smile conditions when the smile photographing mode is selected by the user, but the present invention is not limited to the above, and default initial values set in advance in the digital camera 100 may be used.

In the one and the other embodiments, when the digital camera 100 captures the image of the person for the first time, the data of the smile conditions and so on based on the image of the person, the face parts information, and the determination result are registered to the person data table 15 after the image-capturing is performed by using the smile conditions set by the user, and after that, the data is updated every time when the image-capturing is performed. However, the present invention is not limited to the above. For example, when the person is not registered to the person data table 15, but there are plural images of the person image-captured by the digital camera 100 up to that time in the storage section 10 of the digital camera 100, the user may give an instruction for the CPU 5 to calculate the smile conditions of the person by using the plural images via the operation member 11. The CPU 5 then asks the smile conditions matching with the person based on the processes from the step S10 to the step S19, and may additionally register to the person data table 15 at the storage section 10 of the digital camera 100 in advance.

In the one and the other embodiments, the interval of the predetermined time performing the change of the smile conditions at the step S18 is set to be 30 seconds at the step S17, but the present invention is not limited to the above, and it can be arbitrary determined.

In the one and the other embodiments, the change to remove one of the three conditions of the smile conditions, or to make the values of the conditions of the teeth, the corner of mouth, and the tail of eyes small is performed at the step S18, but the present invention is not limited to the above. For example, it is preferable to change the values of the respective conditions of the smile conditions, a way of change, and so on in the smile photographing mode in accordance with a photographing mode such as a party, a landscape. Namely, in a scene such as the party, participants generally laugh largely, and therefore, the values of the teeth, the corner of mouth, and the tail of eyes of the smile conditions may be set at values larger than the original initial values in advance, or the changes to make the values of these conditions large may be performed at the step S18. On the other hand, at a gathering such as a conference or a social function, it is hesitated to laugh largely, and therefore, the values of the teeth, the corner of mouth, the tail of eyes of the smile conditions may be set at values smaller than the original initial values in advance. Accordingly, for example, it is enabled to select with the scene such as “FORMAL”, “NON-FORMAL”, “ON the Business”, “Office time”, “Party” at the mode setting time, and the values of the respective conditions of the smile conditions are changed in accordance with the selected scene.

Besides, the accuracy of the smile conditions becomes better as the number of photographing times increases, and therefore, the number of images stored at the storage section 10 increases. Accordingly, for example, the smile conditions may be reset to the smile conditions difficult to be determined as the smile by approximating the smile conditions to the default initial value, according to a condition such as a case when the number of photographing times becomes the predetermined times or more to prevent that the number of images increases.

In the one and the other embodiments, the person of the through image 30 does not wear a hat, glasses, or the like, but the present invention is not limited to the above. It is preferable that the determination of the smile is performed by removing the conditions corresponding to a portion when there is the portion where the determination of the smile based on the normal smile conditions cannot be performed caused by the wearing of the hat, the glasses, and so on.

In the one and the other embodiments, the processes in the smile photographing mode are performed till the smile of the person being the subject is obtained as long as all of the smile conditions are removed by the change of the smile conditions at the step S18, but the present invention is not limited to the above. For example, the processes according to the smile photographing mode may be cancelled when any of the teeth, the corner of mouth, the tail of eyes cannot be recognized, or after a certain time (for example, one minute and so on) has passed. However, in this case, it is preferable that a reason why the smile photographing mode is cancelled (for example, “because any of the teeth, the corner of mouth, the tail of eyes cannot be recognized” and so on) is displayed on the display section 13 in addition that a fact that the smile photographing mode is cancelled is displayed.

In the other embodiment, the smile conditions for the person are updated every time when the person is photographed at the step 21, but the present invention is not limited to the above. For example, the update of the smile conditions in the person data table 15 is performed every time when the image-capturing is performed up to the predetermined number of photographing times (for example, for 10 times) from the person is first registered to the person data table 15, but after that, the update of the smile conditions may be performed every certain intervals of the number of photographing times such as 10 times or 20 times.

It is applicable to include a program enabling each function in an imaging device according to the present invention, and to make a computer execute the program. Accordingly, for example, it is possible to ask smile conditions matching with a person even when the person is not registered to the person data table 15 at the storage section 10 of the digital camera 100, by using plural images of the person image-captured by the other digital camera and so on up to that time and analyzing by the computer. It is preferable that the analyzed result is recorded or the like on the memory card 8 and so on, and added to the person data table 15 at the storage section 10 of the digital camera 100 via the memory card 8 and so on.

It is also applicable to a storage medium storing the computer program to enable each function in the imaging device according to the present invention.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

1. An imaging device, comprising:
an imaging section imaging a subject by either of all-pixel readout and thinning-out readout of an imaging sensor and generating an image;
a face detection section detecting a face of the subject by using the image imaged by the thinning-out readout;
a facial recognition section recognizing respective forms of a corner of mouth, teeth, and a tail of eyes along with the face of the subject being detected;
an expression determination section determining that the subject is smiling when the respective forms of the corner of mouth, the teeth, and the tail of eyes being recognized match at least one of smile conditions made up of three conditions determined based on respective forms of a corner of mouth, teeth, and a tail of eyes; and
a control section giving an imaging instruction of the subject by the all-pixel readout to the imaging section when the subject is determined to be smiling by the expression determination section.

2. The imaging device according to claim 1, further comprising
an operation member capable of arbitrarily setting and selecting the smile conditions.

3. The imaging device according to claim 1, wherein
the control section stops giving the imaging instruction to the imaging section when the expression determination section determines that none of the smile conditions is satisfied.

4. The imaging device according to claim 1, further comprising a storage section storing images of faces of a plurality of subjects and each of the smile conditions of the plurality of subjects, wherein
the control section sets the smile conditions of the subject facial recognized by the facial recognition section to the expression determination section when the face of the subject recognized by the facial recognition section is determined to be matching one of the faces of the plurality of subjects stored in the storage section.

5. The imaging device according to claim 4, wherein
the control section further includes a condition updating section updating the smile conditions of the subject stored in the storage section based on a determination result of the expression determination section to the subject in a newly imaged image, and
the control section sets the smile conditions being updated to the expression determination section.

6. The imaging device according to claim 5, wherein
the control section decreases number of the smile conditions and sets the smile conditions whose number being decreased to the expression determination section by each predetermined time interval when the facial recognition section determines that a subject is a new subject which does not exist in the storage section, or when number of update times of the smile conditions of the subject updated by the condition updating section is less than predetermined number of times.

7. The imaging device according to claim 5, wherein
the control section changes the smile conditions of the subject to approximate initial settings and sets the smile conditions of the subject being changed to the expression determination section when determining that number of update times of the smile conditions of the subject updated by the condition updating section is more than predetermined number of times.

8. The imaging device according to claim 1, further comprising
a display section displaying a determination result of the smile conditions determined by the expression determination section when the subject is imaged by the imaging section.

9. The imaging device according to claim 1, wherein
the control section adds a determination result of the smile conditions of the subject at a time of imaging of the expression determination section to the image in which the imaging section images the subject.

10. A computer-readable storage medium storing a program causing a computer to execute:
an input operation reading an image in which a subject is imaged by an imaging sensor;
a face detecting operation detecting a face of the subject by using the image;
a facial recognizing operation recognizing respective forms of a corner of mouth, teeth, and a tail of eyes along with the face of the subject being detected;
an expression determining operation determining that the subject is smiling when the respective forms of the corner of mouth, the teeth, and the tail of eyes being recognized match at least one of smile conditions made up of three conditions determined based on respective forms of a corner of mouth, teeth, and a tail of eyes; and
a storing operation storing the smile conditions at a time the subject is determined to be smiling as smile conditions of the subject when the expression determining operation determines that the subject is smiling.
